(19) United States
(12) Patent Application Publication
(10) Pub. No.: US 2026/0027873 A1
(43) Pub. Date: Jan. 29, 2026

(54) Off-Road Vehicle and Windshield Assembly

(71) Applicant: Zhejiang CFMOTO Power Co., Ltd., Hangzhou (CN)

(72) Inventors: Ronglei Mo, Hangzhou (CN); Zhiyong Li, Hangzhou (CN); Zhiguo Xie, Hangzhou (CN)

(21) Appl. No.: 19/344,332

(22) Filed: Sep. 29, 2025

Related U.S. Application Data
(63) Continuation of application No. PCT/CN2024/089751, filed on Apr. 25, 2024.

(30) Foreign Application Priority Data
Apr. 27, 2023 (CN) 202310489078.3

(51) Int. Cl. B60J 1/04; B60J 1/00; B60R 21/13; B60S 1/08; B60S 1/16; B60S 1/52; B62D 25/14

(52) U.S. Cl. CPC B60J 1/04; B60J 1/007; B60R 21/13; B60S 1/08; B60S 1/16; B60S 1/52; B62D 25/14

(57) ABSTRACT

An off-road vehicle includes a frame, a plurality of wheels, a vehicle cover, a roll-over protection system (ROPS), a windshield assembly and a latch. The windshield assembly is pivotally mounted relative to the frame for pivoting about a pivot axis. The windshield assembly includes a support arm rigidly positioned relative to a windshield frame. Via engagement with either of two openings on the support arm, the latch such as a barrel bolt latch mounted on a top of the dashboard can secure and hold the windshield assembly in either a fully closed position or a partially opened position. An alternative embodiment uses an arc-shaped slot receiving a transversely extending handle bolt, so the size of the opening for the partially opened position can be selected by the user.

### RELATED APPLICATION INFORMATION

The present invention is a continuation of PCT/CN2024/089751 entitled “All-Terrain Vehicle And Windshield Assembly Thereof”, filed with the Chinese Patent Office on Apr. 25, 2024, and claims the benefit of priority to Chinese Patent Application No. 202310489078.3, entitled “All-Terrain Vehicle And Windshield Assembly Thereof”, filed with the Chinese Patent Office on Apr. 27, 2023. The entire contents of the above-referenced applications are incorporated herein by reference.

### FIELD OF THE DISCLOSURE

The present invention relates to the field of vehicles, and particularly to an off-road vehicle and a windshield assembly thereof.

### BACKGROUND OF THE DISCLOSURE

An off-road vehicle is a type of vehicle that can travel on all terrains, having high ground clearance, a suspension with excellent shock absorption, tires with low pressure so as to provide good grip, and strong power. Compared to ordinary on-road vehicles, off-road vehicles are capable of driving in extremely harsh environments, including but not limited to beaches, mountains, forests, swamps, and other terrains, and have been widely used in farms and entertainment venues.

For off-road vehicles with a cab, the cab is generally supported by the frame, and doors are optionally installed on both sides of the cab. Many such off-road vehicles include a front windshield assembly at the front end of the cab, which is directly connected to the frame and possibly to a roll-over protection system (“ROPS”). The front windshield assembly can be difficult to assemble and disassemble, both as a component as when connecting or replacing the front windshield assembly to the frame and/or ROPS. The front windshield assembly of many off-road vehicles is fixed and cannot be opened. Other off-road vehicles include a front windshield assembly which is pivotably connected but can only be secured at fully opened or fully closed positions. In order to meet the requirements of disassembly and assembly, it is necessary to provide a windshield assembly that is easy to assembly and disassembly. Many off-road vehicles include a windshield wiper for cleaning the windshield of the front windshield assembly, most commonly with the wiper and windshield washer fluid nozzle fixedly mounted on the frame or ROPS.

How to reasonably arrange the positions of the windshield, wiper and nozzle at low cost, while keeping the driver's line of sight clear, is a problem. Better solutions are needed in this field.

### SUMMARY OF THE INVENTION

Embodiments of the present invention provide off-road vehicles to solve at least one problem existing in the background.

In a first aspect, an embodiment provides an off-road vehicle, which includes a frame, a plurality of wheels, a vehicle cover, a roll-over protection system (ROPS), a windshield assembly and a latch. The plurality of wheels support the frame through a suspension. The vehicle cover is at least partially arranged on the frame and includes a dashboard. The windshield assembly is pivotally mounted relative to the frame for pivoting about a pivot axis between a fully closed position of the windshield and a fully opened position of the windshield. The fully closed windshield assembly and the dashboard jointly define a front of a cab under the ROPS. The windshield assembly includes a windshield; a windshield frame; and a support arm rigidly positioned relative to the windshield frame. Via engagement with the support arm, the latch can secure and hold the windshield assembly in either the fully closed position or a partially opened position.

In a second aspect, the windshield assembly is hinged to an upper front cross-bar of the ROPS with a right hinge and a left hinge. The support arm is at a mid position on a transversely extending bottom bar. The latch is a barrel bolt latch with a housing mounted on a top of the dashboard. The bolt of the barrel bolt latch is slidably movable relative to the housing via use of a handle. The a distal end of the bolt mates into either of at least two mating openings in the support arm so as to secure and hold the windshield assembly in either the fully closed position or the partially opened position.

In a third aspect, the support arm defines an arc shaped slot centered about the pivot axis. The latch is a transversely extending handle bolt which is threaded into a housing mounted on a top of the dashboard. The handle bolt can be hand turned to tighten or loosen the handle bolt relative to the support arm and the housing, such that a shank of the handle bolt can be received in the arc shaped slot and the handle bolt tightened to frictionally support the windshield assembly in either the closed position or a range of partially opened positions.

In a fourth aspect, the windshield frame includes a first windshield frame portion and a second windshield frame portion. Each of the first and second windshield frame portions define part of a receiving peripheral space for the windshield. Joining of the first windshield frame portion to the second windshield frame portion around the windshield completes clamping of the windshield to the windshield frame.

For better understanding of other features, objectives, and advantages of the present invention, the details of one or more embodiments of the present invention are described in the following drawings and description.

### BRIEF DESCRIPTION OF THE DRAWINGS

The drawings described herein are intended to provide further understanding of the present invention. The illustrative embodiments and their descriptions are used to explain preferred embodiments of the present invention but do not constitute limitations of the present invention. In the drawings:

FIG. 1 is a front left perspective view of an off-road vehicle having a preferred windshield assembly in accordance with the present invention, shown in a partially-opened supported position.

FIG. 2 is a left side view of the off-road vehicle of FIG. 1.

FIG. 3 is an exploded view of primary portions of the preferred windshield assembly of FIGS. 1 and 2.

FIG. 4 is an enlarged view of section 4 of FIG. 3.

FIG. 5 is a rear left perspective view of the windshield frame assembly of FIGS. 1-4, shown in the partially-opened supported position of the locking device, and without showing the wiper device.

FIG. 6 is a rear left perspective view of the windshield frame assembly of FIGS. 1-5, shown in fully closed position.

FIG. 7 is an enlarged view of section 7 of FIG. 5.

FIG. 8 is an enlarged view of section 8 of FIG. 6.

FIG. 9 is a left side view of the off-road vehicle of FIGS. 1 and 2, showing the windshield assembly in the fully closed position.

FIG. 10 is a left side view of the off-road vehicle of FIGS. 1, 2 and 9, showing the windshield assembly in the fully opened supported position.

FIG. 11 is a rear left perspective view of an alternative bottom portion of a frame assembly in accordance with the present invention, shown in a partially-opened supported position.

FIG. 12 is a rear left perspective view of the alternative bottom portion of the frame assembly of FIG. 11, shown in a fully-closed position.

FIG. 13 is a front view of the off-road vehicle of FIGS. 1 and 2, also showing a different end-of-travel position of the wiper blade in dashed lines.

FIG. 14 is an enlarged view of portion 14 of FIG. 13.

FIG. 15 is a rear left perspective view of the preferred motor and pump in the wiper device and windshield assembly and top of the ROPS of the off-road vehicle of FIGS. 1, 2, 9, 10 and 13.

FIG. 16 is a schematic diagram of the active components of the wiper device for the windshield assemblies of FIGS. 1-15.

### DETAILED DESCRIPTION

For better understanding of the above objects, features and advantages of the present invention, embodiments of the present disclosure will be described in detail below with reference to the accompanying drawings.

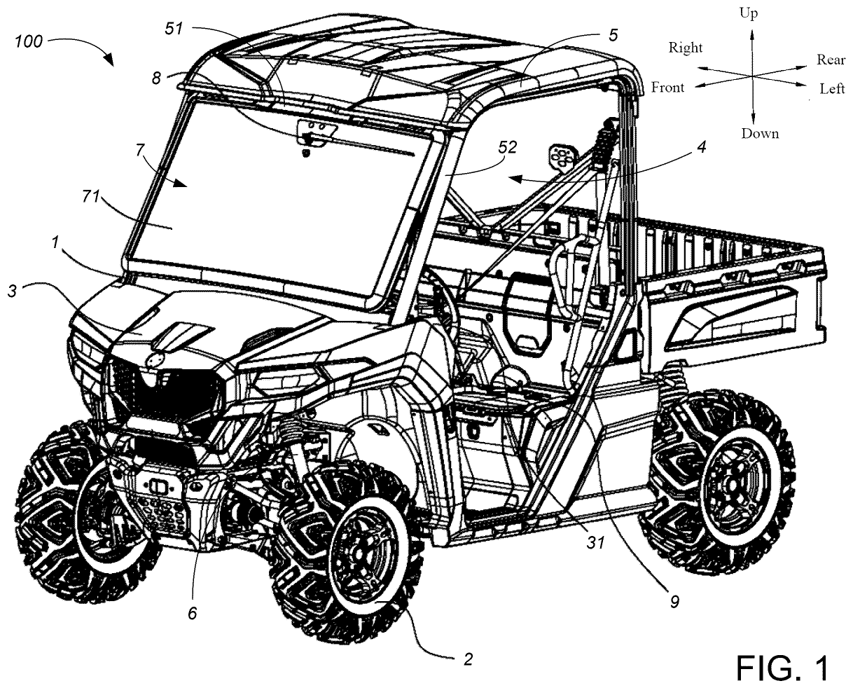

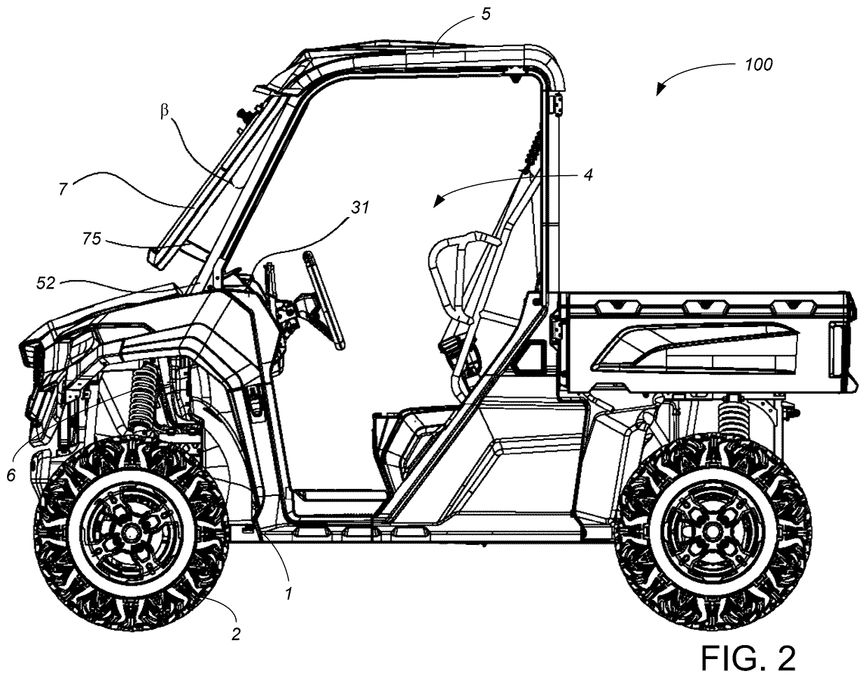

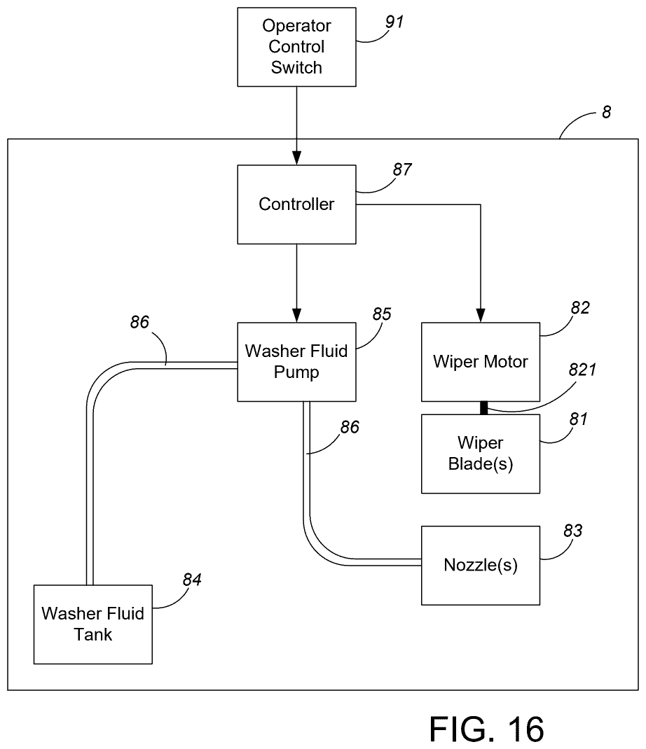

As shown in FIGS. 1 and 2, the present invention provides an off-road vehicle 100, which includes a frame 1, a plurality of wheels 2, a vehicle cover 3, and a cab 4. The frame 1 is used to form the overall structure of off-road vehicle 100, with a roll-over protection system (“ROPS”) 5 defining the top of the cab 4. The frame 1 is supported on the plurality of wheels by a suspension 6. At least some of the plurality of wheels 2 are rotationally driven by a prime mover assembly (not shown) to cause the off-road vehicle 100 to travel. The wheels 2 preferably include low pressure tires for better traction on off-road terrain. The vehicle cover 3 is supported by the frame 1, and covers at least portions of the frame 1 and underlying vehicle components to protect and conceal such underlying vehicle components. The cab 4 is defined in part by a dashboard 31 and a windshield assembly 7 at the front of the cab 4. The dashboard 31 is supported by the frame 1, and the windshield assembly 7 is supported by the frame 1 and/or the ROPS 5. A wiper device 8 is provided for cleaning of the windshield 71 of the windshield assembly 7. The off-road vehicle 100 further includes an electrical system 9, which includes a battery (not separately shown) supported by the frame 1. The electrical system 9 also includes instruments (not separately shown) mounted on the dashboard 31 to display driving information of the off-road vehicle 100 as well as switches or other controls (not separately shown other than wiper control switch 91 in FIG. 16) arranged on the dashboard 31 or otherwise accessible within the cab 4 for the driver and/or passenger to control operation of the off-road vehicle 100.

For better understanding of the present invention, the directions of “front”, “rear”, “left”, “right”, “up” and “down” are defined in FIG. 1. In the present invention, a length or longitudinal direction refers to a front-rear direction shown in FIG. 1, a width, lateral or transverse direction refers to a left-right direction shown in FIG. 1, and a height or vertical direction refers to an up-down direction shown in FIG. 1, all assuming the vehicle 100 is on generally level ground.

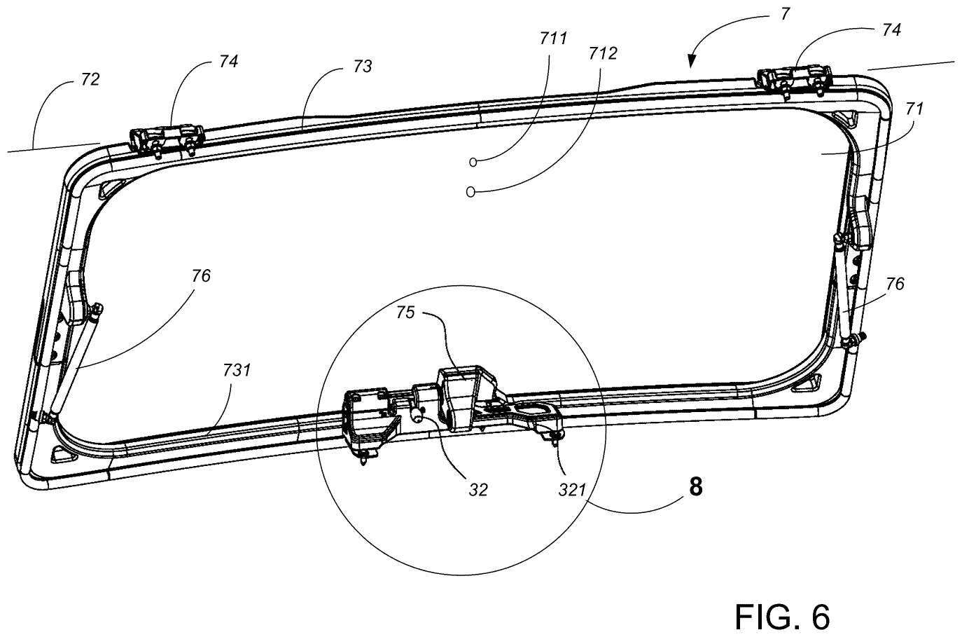

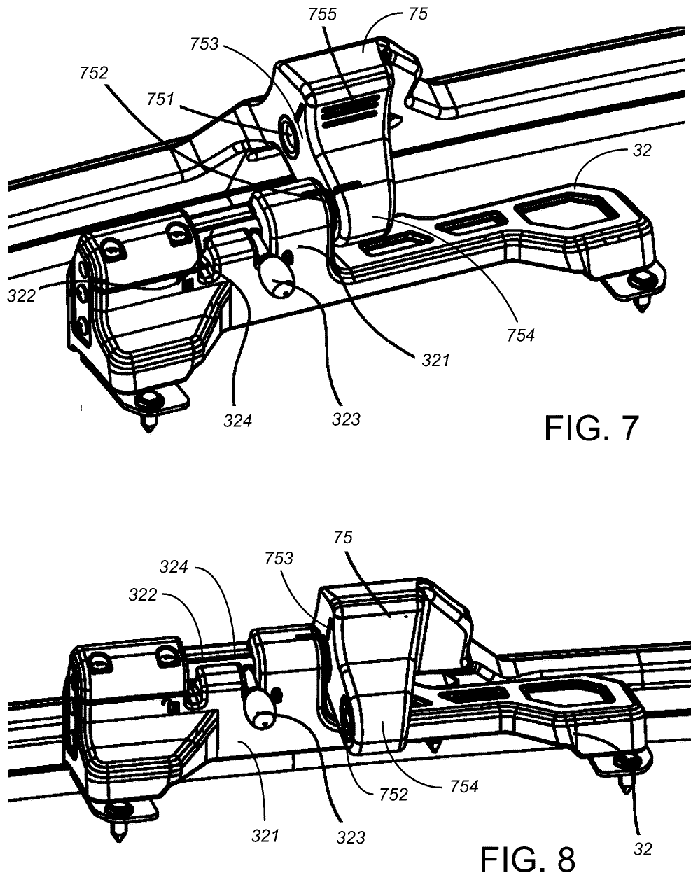

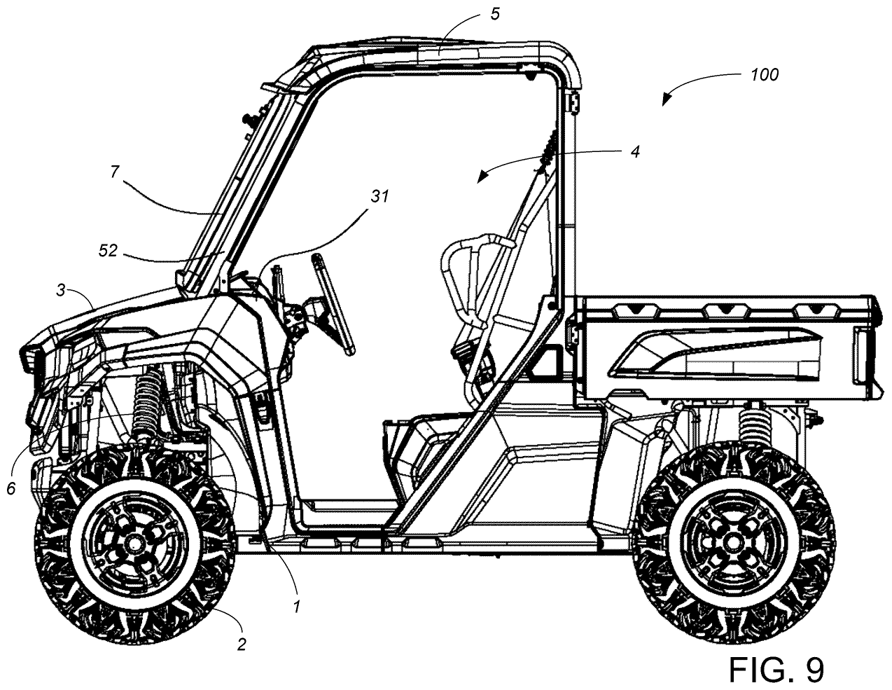

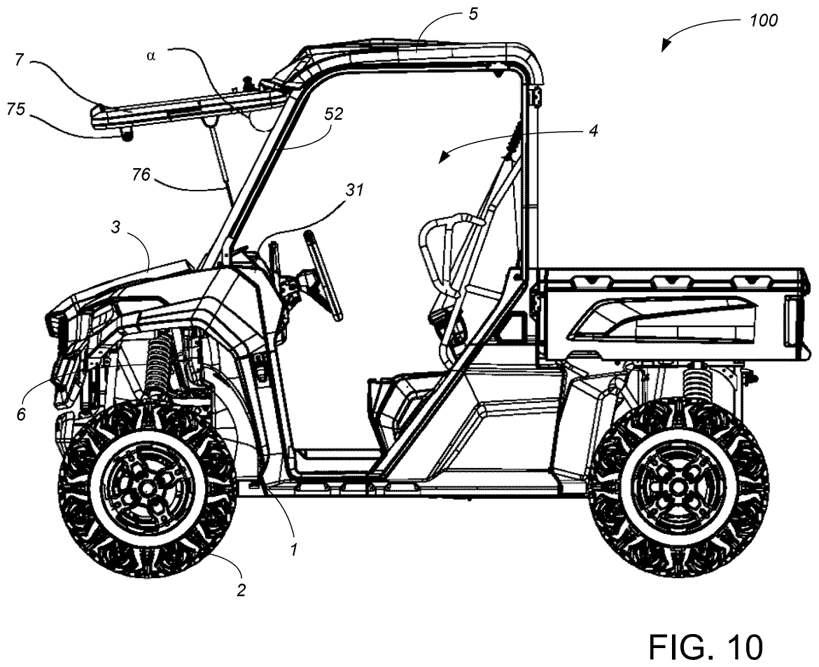

At least the windshield 71 and more preferably the entire windshield assembly 7 is hinged, preferably along the top edge of the windshield assembly 7, for pivoting about a horizontal, transversely extending pivot axis 72. The pivoting allows the windshield 71 to have three supported positions: a fully closed position, a partially opened position and a fully opened position. FIGS. 1, 2, 5 and 7 show the windshield assembly 7 with the windshield 71 in the partially opened position. FIGS. 6, 8 and 9 show the windshield assembly 7 with the windshield 71 in the fully closed position. FIG. 10 shows the windshield assembly 7 with the windshield 71 in the fully opened position.

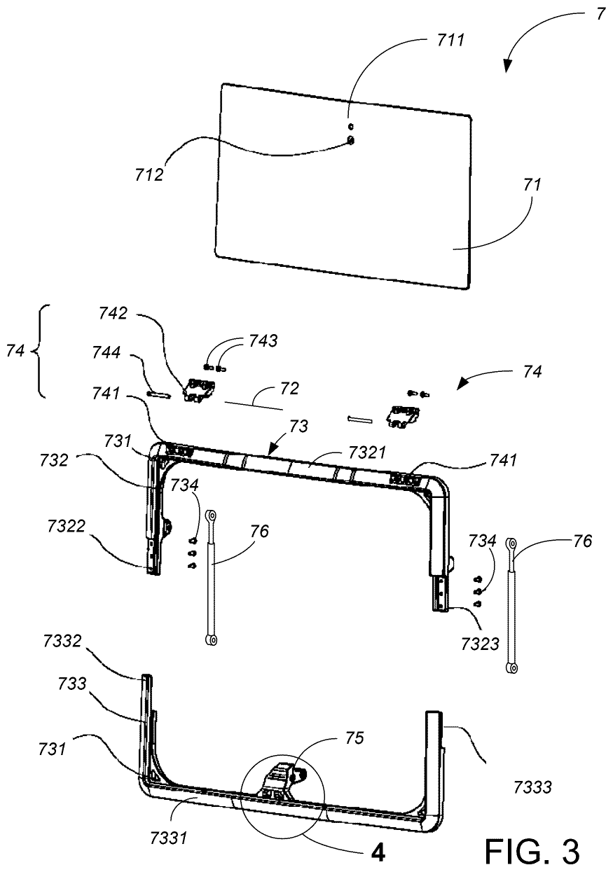

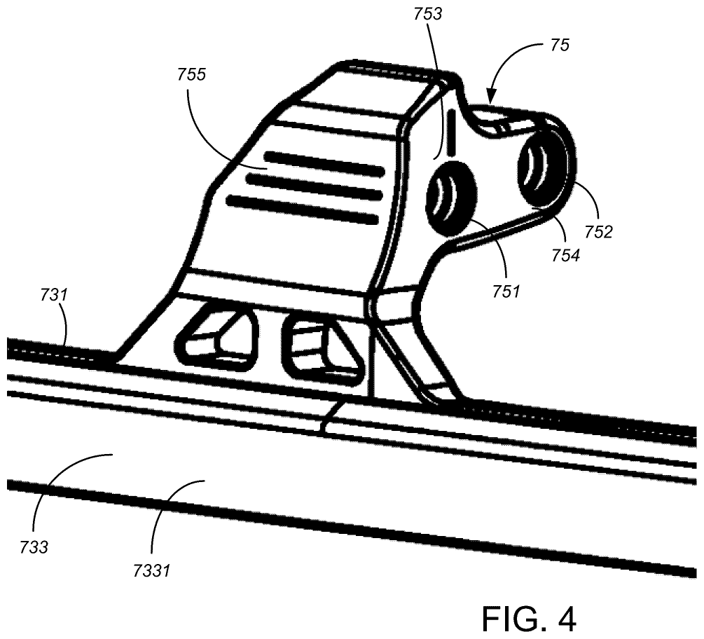

Components of the preferred windshield assembly 71 are best shown in FIG. 3. The windshield assembly 7 includes the windshield 71, a windshield frame 73, one or more hinges 74, at least one rigid support arm 75, and one or two side supports 76. The windshield frame 73 defines a receiving peripheral space 731, and the periphery of the windshield 71 is received in the receiving peripheral space 731. The windshield frame 73 is pivotably connected to an upper front cross-bar 51 of the ROPS 5 through the hinges 74. The rigid support arm 75 is used to hold the windshield frame 73 in the fully closed and partially opened positions. The side support(s) 76 are used to hold the windshield frame 73 up in the fully opened position.

While the windshield frame 73 could be a single, integrated structure, more preferably the windshield frame 73 is designed as a split type, which includes at least a first windshield frame portion 732 and a second windshield frame portion 733. The first windshield frame portion 732 and the second windshield frame portion 733 are adapted to be connected together to form the windshield frame 73. In the preferred embodiment, the first windshield frame portion 732 is for the upper half of the windshield 71 and includes a transversely extending top bar 7321 and right and left downwardly extending side legs 7322, 7323, and the second windshield frame portion 733 is for the lower half of the windshield 71 and includes a transversely extending bottom bar 7331 and right and left upwardly extending side legs 7332, 7333. In another embodiment, the windshield frame 73 is split left to right. In another embodiment, one pair of side legs are made twice as long and only included either on the first windshield frame portion or on the second windshield frame portion, and the other pair of side legs are omitted. In yet other embodiments, more than two windshield frame portions are provided. In the preferred embodiment, the right side legs 7322, 7332 are connected together using three screws 734, and the left side legs 7323, 7333 are connected together using three screws 734. Other connection structures, such as riveting, insertion, center connection, or the like, can equivalently be used. By forming the windshield frame 73 as a split type, the receiving peripheral space 731 can wrap further around the edge of the windshield 71 (i.e., both in front of, outside of, and behind the edge), avoiding the need for adhesive attachment of the windshield 71 to the windshield frame 73. The windshield frame portions 732, 733 are only connected together after the windshield 71 is placed into the receiving peripheral space 731, with attachment of the connection screws 734 completing clamping of the windshield 71 to the windshield frame 73. Forming the windshield frame 73 as a split type reduces the assembly difficulty of the windshield 71 and the windshield frame 73, important both during vehicle assembly and for replacement of a broken or damaged windshield 71. A gasket or other sealing strip (not shown) can be used to create a fluid-tight or air-tight seal between the windshield 71 and the windshield frame 73, primarily to prevent precipitation ingress when the windshield 71 is in the closed position.

The hinge(s) 74 allow pivoting of the windshield assembly 7 from the fully closed position to the fully opened position. As called out in FIG. 10, the fully opened position is offset from the fully closed position by a pivot angle α of the windshield assembly 7 which is preferably in the range from 60 to 70°, more preferably in the range from 62 to 68°, and most preferably in the range from 64 to 66°. Having a value for the pivot angle α which is within these ranges allows for easy opening and closing and also allows for better support of the windshield assembly 7 in the fully opened position by the side support(s) 76. Having a value for the pivot angle α which is within these ranges also usually results in the windshield 71 being horizontal or nearly horizontal in the fully opened position of the FIG. 10, so wind generated during driving of the off-road vehicle 100 with the windshield assembly 7 fully opened is less likely to damage the windshield assembly 7.

The preferred embodiment includes two hinges 74 widely spaced toward right and left sides of the windshield assembly 7 to pivotably attach the windshield assembly 7 to the ROPS 5. Other embodiments utilize a single hinge or more than two hinges. In the preferred embodiment, each of the hinges 74 include one of their leaves/knuckles 741 integrally formed with the transversely extending top bar 7321 of the windshield frame 73. The other leaf 742 of the hinges 74 is attached to the upper front cross-bar 51 of the ROPS 5, such as via screws 743. Alternatively, both leaves 741, 742 of each of the hinge(s) 74 can be separately formed and attached to the relative cross-member 51, 7321 such as via screws 743 or by welding. Each of the hinges 74 has a removable hinge pin 744 for ease of assembly and disassembly, with the removable hinge pins 744 being aligned to define the pivot axis 72.

The preferred side supports 76 are gas springs arranged on the right and left sides of the windshield assembly 7. One end (preferably the bottom end) of each of the gas springs 76 is mounted on a column 52 of the ROPS 5 as best shown in FIG. 10, and the other end is mounted on the downwardly extending side legs 7322, 7323 of the windshield frame 73. The gas springs 76 are capable of extending and retracting and providing a pre-load force. When the windshield assembly 7 is closed, the gas springs 76 are in a retracted state extending substantially parallel to the plane of the windshield frame 73. During the opening process of the windshield assembly 7, the gas springs 76 extend at an increasing angle relative to the column 52 of the ROPS 5 and relative to the windshield frame 73, providing an increasing upward flipping force on the windshield assembly 7. When the windshield assembly 7 is fully opened to its limit position, the gas springs 76 extend to their greatest length, and at this time, the side supports 76 are substantially perpendicular to the plane of the windshield frame 73. As the gas springs 76 approach their greatest length, the gas springs 76 provide a force which supports the gravitational moment of the windshield assembly 7 about the pivot axis 72, but which force can be overcome by hand moving of the distal end of the windshield assembly 7 downwardly.

The rigid support arm 75 extends rigidly from the windshield frame 73 (in a fixed position relative to the windshield frame 73), preferably from the transversely extending bottom bar 7331 at a middle lateral position between the two hinges 74. The positions of the two hinges 74 and the rigid support arm 75 preferably define a triangle, to more stably hold the windshield assembly 7 fully closed.

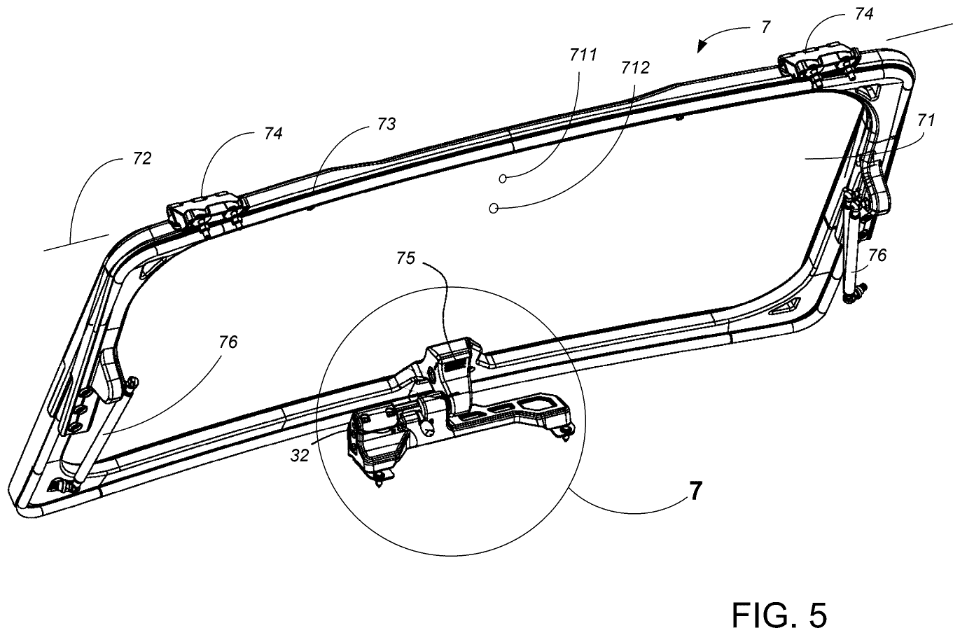

FIGS. 5-8 show a preferred locking device 32 which interacts with the rigid support arm 75. The locking device 32 is mounted relative to the vehicle frame 1, such as on the front top of the dashboard 31. The preferred locking device 32 is a barrel bolt latch, similar to that taught in U.S. Pat. No. 5,125,695, incorporated by reference. The barrel bolt latch 32 includes a barrel as part of its housing 321, which barrel preferably extends in the transverse direction. A bolt 322 within the barrel is hand movable/slidable relative to the barrel housing 321, such as via a handle 323 which is exposed through a window 324. As known in the field of barrel bolt latches, the bolt 322 can be hand moved between a latching position where a distal end of the bolt 322 extends out of the barrel housing 321 and an unlatched position where the distal end of the bolt 322 is still within the barrel housing 321.

When in the latching position, the distal end of the bolt 322 can be received in either of multiple (preferably two) mating openings 751, 752 in the rigid support arm 75. Both of the mating openings 751, 752 are behind the plane of the windshield 71. The first mating opening 751 is positioned relative to the locking device 32 to hold the windshield assembly 7 in the fully closed position, and can be considered to be defined by a locked-closed keeper portion 753 of the rigid support arm 75. The second mating opening 752 is positioned behind the locked-closed keeper portion 753, but at the same distance from the pivot axis 72 as the first mating opening 751, and can be considered to be defined by a partially-opened keeper portion 754 of the rigid support arm 75. The partially-opened keeper portion 754 is positioned relative to the locking device 32 to hold the windshield assembly 7 in the partially opened position. If desired, the distal end of the bolt 322 can be tapered to make it easier to position the distal end of the bolt 322 into one of the mating openings 751, 752.

In the preferred embodiment, the distance between the first mating opening and the second mating opening 752 allows the windshield assembly 7 to be held at a partially open position angle β (called out in FIG. 2) in the range of greater than 0 to 10° about the pivot axis 72 from its closed position, more preferably held at a partially open position angle β which is pivoted in the range of 2 to 8° about the pivot axis 72 from its closed position, and most preferably held at a partially open position angle β which is pivoted in the range of 4 to 6° about the pivot axis 72 from its closed position. In longitudinal distance terms, the second mating opening 752 is preferably within the range of 20 to 100 mm behind the first mating opening 751, so the partially opened position of the windshield 71 opens a gap of about 20 to 100 mm between the transversely extending bottom bar 7331 and the dashboard 31, allowing ventilating air to flow under the partially opened windshield assembly 7 and into or out of the cab 4.

In the preferred embodiment shown, the bolt 322 of the barrel bolt latch 32 is positioned to the left of the rigid support arm 75, making the handle 323 more easily reached by the driver. At the same time, the housing 321 extends further to the right in the vehicle 100 than the rigid support arm 75, allowing for widely spaced attachment locations for the housing 321 to be attached to the top of the dashboard 31. The wide housing 321 better withstands impact between the bolt 322 and the rigid support arm 75 in cases where the driver attempts to lock the windshield assembly 7 without first fully aligning the bolt 322 and one of the mating openings 751, 752, particularly likely if a leaf, twig or other debris (not shown) is present in the gap at the bottom of the windshield assembly 7 when the driver is attempting to lock the windshield 71 closed. The wide housing 321 also better transfers forces between the windshield assembly 7 and the dashboard 31 to more tightly hold the windshield assembly 7 closed over years of use.

The rigid support arm 75 preferably includes a grip surface 755 which can be used to hand manipulate the windshield assembly 7 for opening or for closing from within the cab 4 of the off road vehicle 100. The grip surface 755 preferably includes ridges or other texture for better gripping particularly while pulling the windshield assembly 7 closed.

Use of the barrel bolt latch 32 is simple and straight forward. From the locked closed position, when the user wants to open the windshield 71, the user simply uses one hand to pull the handle 323 of the bolt 322 to the left in the window 324, moving the distal end of the bolt 322 out of the locked-closed keeper portion 753, while pushing on the grip surface 755 to open the windshield assembly 7. If the user desires to use the partially-opened position, the user pushes the windshield assembly 7 until the bolt 322 aligns with the second mating opening 752, and then pushes the handle 323 of the bolt 322 to the right so the distal end of the bolt 322 moves into the partially opened keeper portion 754. If the user desires to use the fully-opened position, the user pushes the windshield assembly 7 further forward until the gas springs 76 overcome the gravitational weight/moment of the windshield assembly 7, and the force of the gas springs 76 pushes the windshield assembly 7 further upward to the end-of-travel fully opened position. Closing of the windshield assembly 7 simply involves the reverse procedure.

In some embodiments, the bolt 322 is spring biased toward the latched position. The distal end of the bolt 322 can then have a tapered front edge (not shown) which enables forced closing of the windshield assembly 7 to push the bolt 322 leftward against the spring force, until it snaps rightwardly under the spring force into place in one of the mating openings 751, 752.

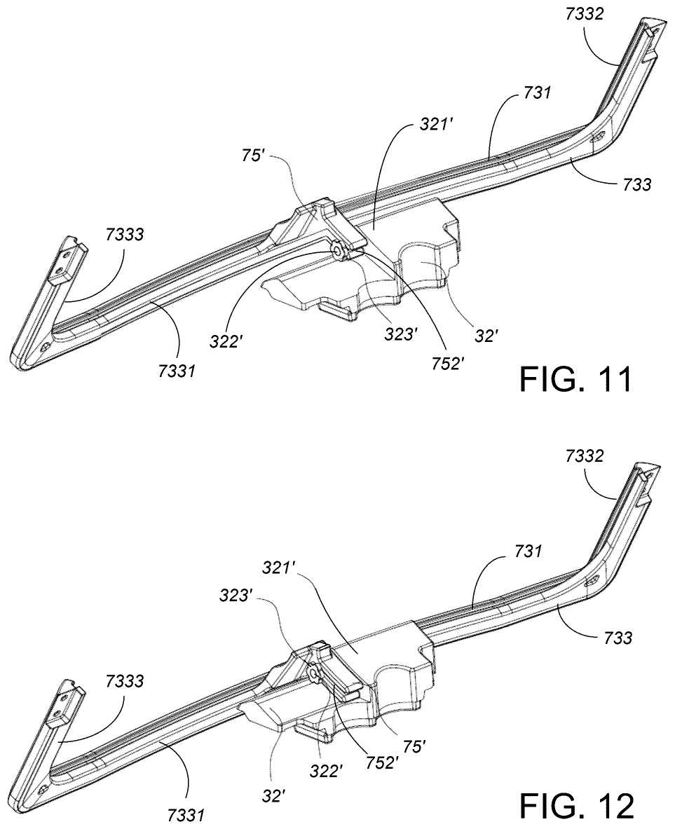

FIGS. 11 and 12 show an alternative rigid support arm 75′ and locking device 32′ in accordance with the present invention. In this embodiment, the transversely slidable bolt 322 with its handle 323 is replaced with a handle bolt 322′ extending transversely which is threaded into the housing 321′. The handle bolt 322′ can be hand turned via a knob 323′ clockwise or counterclockwise to tighten or loosen the handle bolt 322′. The first and second mating openings 752 are replaced with a single arc shaped slot 752′, shaped, oriented and positioned to receive the shank of the handle bolt 322′. With this alternative rigid support arm 75′ and locking device 32′, the windshield assembly 7 can be held at any partially opened angle β between 0° (when the shank of the handle bolt 322′ is fully forward in the arc shaped slot 322′) and the rear end of the arc shaped slot 322′. The arc shaped slot 322′ extends circumferentially about the pivot axis 72, extending with a length that preferably allows the partially opened position to be held up to 15° from the fully closed position, but a 15° long slot 322′ extends a considerable distance into the cab 4 when in the fully closed position. Accordingly, the arc shaped slot 322′ is more preferably somewhat shorter in the circumferential direction, such as extending 10° or most preferably 6° about the pivot axis 72. Once the position of the windshield assembly 7 is cracked open a sufficient amount to achieve the ventilation effect desired by the user, the user simply turns the knob 323′ clockwise to tighten the handle bolt 322′ until friction between the support arm 75′ and the handle bolt 322′/housing 321′ hold the windshield assembly 7 in place. This alternative embodiment is beneficial in that it allows the user to have finer control over the amount that the window assembly 7 is held open beyond a single partially opened position. However, the off road vehicle 100 is often driven over bumpy terrain, and such jarring can overcome the friction force if the handle bolt 322 is not adequately tightened.

The purpose of the wiper device 8 is to clean a wiped portion of the windshield 71 and provide the driver with good visibility. While the wiper device 8 could be mounted on the frame 1 or ROPS 5 of the off road vehicle 100, more preferably the wiper device 8 is mounted on the windshield assembly 7.

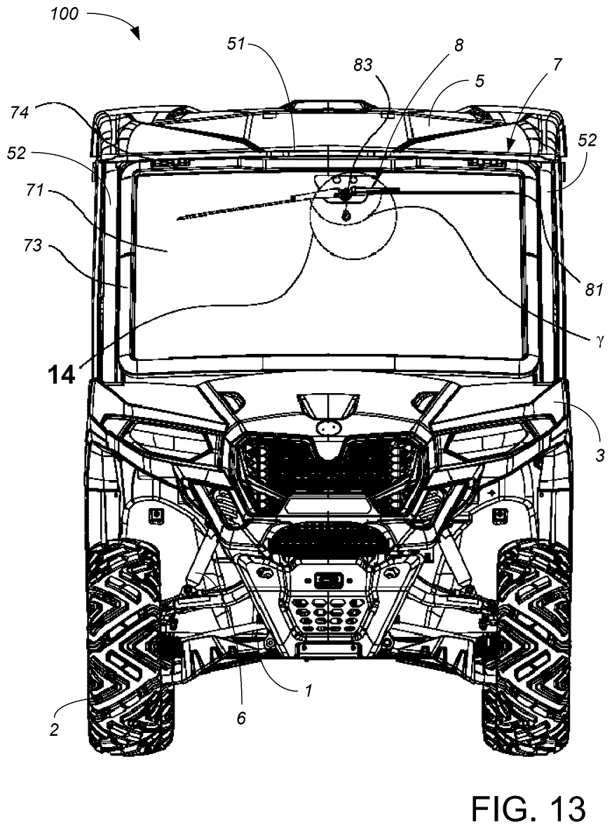

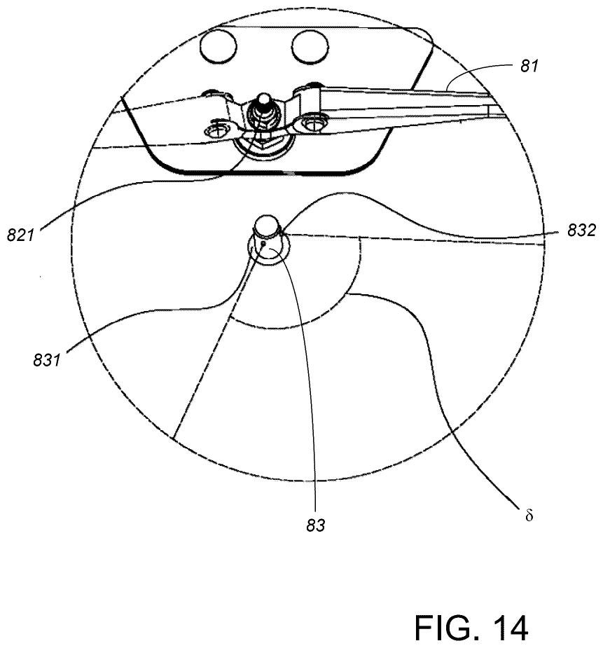

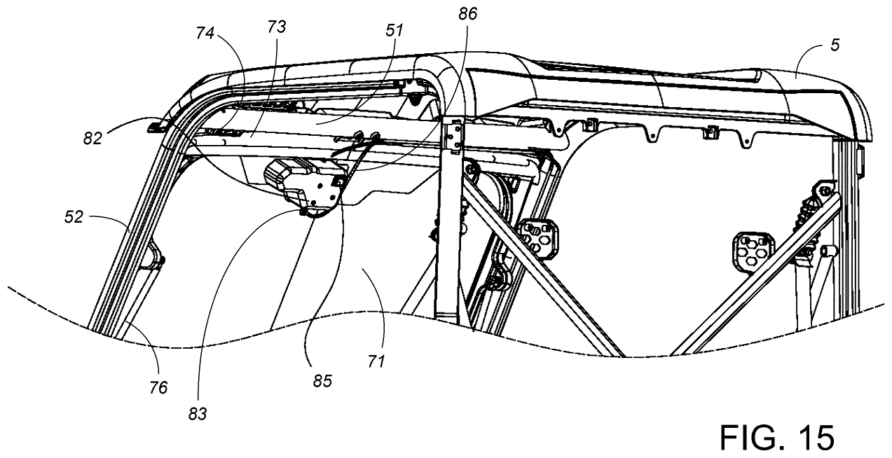

The wiper device 8 is further explained with reference to FIGS. 13-16. The wiper device 8 includes at least one wiper blade 81, shown in FIGS. 13 and 14 in solid lines at a left-most end-of-travel position and in dashed lines at a right-most end-of-travel position. The wiper blade 81 moves from side to side to wipe the outside surface of the windshield 71.

The wiper device 8 further includes an electric motor 82, a spray nozzle 83, a washer fluid tank 84 (shown only in FIG. 16), a washer fluid pump 85, and tubing 86 connecting the washer fluid pump 85 between the spray nozzle 83 and washer fluid tank 84. The motor 82 is mounted with its housing inside the cab 4, with an output shaft 821 which extends through a through hole 711 of the windshield 71, with the through hole 711 best shown in FIGS. 3, 5 and 6. For embodiments with a single wiper blade 81, the motor shaft through hole 711 is preferably positioned in the upper middle of the windshield 71 so the wiper blade 81 wipes underneath the through hole 711, although alternative embodiments position the motor shaft through hole in the lower middle of the windshield 71 and orient the wiper blade so it cleans above the motor shaft through hole. Instead of centered right to left on the windshield 71, the motor shaft through hole may alternatively be positioned slightly on the driver's side of the vehicle 100. The wiper blade 81 is detachably connected to the output shaft 821, to swing back and forth relative to the windshield 71 under the driving of the motor 82. As called out in FIG. 13 between the solid line position of the wiper blade 81 and the dashed line position of the wiper blade 81, the maximum swing angle γ of the wiper blade 81 is preferably in the range from 150 to 170°, more preferably in the range from 155 to 165°, and most preferably in the range from 158 to 162°. If the maximum swing angle γ of the wiper blade 81 is too great, the wiper blade 81 may travel off the surface of the windshield 71 and/or prematurely wear the rubber/flexible wiper element. If the maximum swing angle γ of the wiper blade 81 is too small, the cleaning effect of the wiper blade 81 is insufficient.

The motor 82 is electrically connected to the electrical system 9 through an operator control switch 91 (shown only in FIG. 16), with the operator control switch 91 mounted in the cab 4 of the off road vehicle 100 (preferably on or just behind the dashboard 31, although an alternative embodiment positions the operator control switch 91 on the housing of the motor 82) for access by the driver while driving. The wiper control switch 91 may be a button with multiple positions, such as “turn on the wiper blade”, “turn on the wiper blade and spray washer fluid simultaneously”, “turn off the wiper blade and spray washer fluid”, etc. In some embodiments, a windshield sensor (not shown) may be used to monitor windshield conditions, and interact with the wiper control switch 91 to automatically or semi-automatically control the start and stop of the motor 82 and the washer fluid pump 85. The operator control switch 91 preferably controls both the wiper motor 82 and the washer fluid pump 85 such as through a controller 87 (shown only in FIG. 16).

The nozzle 83 is detachably connected to the windshield 71 through a nozzle mounting throughhole 712. The nozzle mounting throughhole 712 is preferably positioned adjacent the motor shaft through hole 711, such as immediately underneath the motor shaft through hole 711. Washer fluid is pumped from the washer fluid tank 84 through the tubing 86 to the nozzle 83 by the washer fluid pump 85, and the nozzle 83 sprays washer fluid onto the windshield 71 under the control of the washer fluid pump 85. The wiper control switch 91 preferably is also electrically connected to the washer fluid pump 85 to control the spray.

The nozzle 83 includes a connection stem 831 that passes through the nozzle mounting throughhole 712 of the windshield 71 and one or more spray outlet holes 832. The nozzle 83 preferably sprays washer fluid in an arc within a predetermined range, with a preferred washer fluid arc angle δ as shown in FIG. 14 being in a range of 70 to 110°, more preferably the range from 80 to 100°, and most preferably in the range from 90 to 95°. In some embodiments, the nozzle 83 has two washer fluid outlet holes 832, each oriented to define the end of the washer fluid arc angle δ such as being directed 90° apart. Because washer fluid sprayed out of each of the two washer fluid outlet holes 832 diverges, it is not necessary for the orientation of the two washer fluid outlet holes 832 to intersect or overlap to meet the spraying demand.

The connection stem 831 allows the directional orientation of the spray outlet(s) 832 to be turned and readjusted by the user, so the driver can adjust the washer fluid spraying direction of the nozzle 83. Therefore, the spraying area of the nozzle 83 can be reasonably matched with the wiper blades 81 to clean the windshield 71 without interfering with the driver's field of view.

The material of the windshield 71 is translucent, but is preferably less brittle than glass, and is preferably a colorless and transparent amorphous thermoplastic material. As an example, the material of the windshield 71 may be PC polycarbonate, which is not only transparent with high strength, toughness, and impact resistance, but is also convenient for drilling or cutting mounting holes 711, 712. Because PC polycarbonate is less brittle than glass, the wiper device 8 may be directly mounted on the windshield 71 through the mounting holes 711, 712, without the need to defines mounting points on the frame 1 or ROPS 5, and the overall structure is compact. Therefore, the wiper device 8 can be freely replaced on the windshield 71 without interference from other components. The positions for drilling mounting holes 711, 712 can be selected differently for each windshield 71, making it easier to adapt the same windshield 71 for different vehicle models, thereby making the design highly versatile. The number of wiper blades 81 and nozzles 83 may also be easily changed from windshield to windshield. It should be noted that the windshield 71 may also be made of other transparent materials with high strength, toughness, and impact resistance that are convenient for cutting and punching, as long as the above effects are achieved by being less brittle than glass.

It should be understood that for those skilled in the art, improvements or transformations can be made based on the above description, and all such improvements and transformations should fall within the scope of protection of the claims attached to this application. The above descriptions only express several embodiments of the present invention, and their descriptions are specific and detailed, but should not be understood as limiting the scope of patent protection. For ordinary technical personnel in this field, modifications and improvements can be made without departing from the concept of this invention, and the scope of protection should be based only on the attached claims.

1. An off-road vehicle comprising:
a frame;
a plurality of wheels supporting the frame through a suspension;
a vehicle cover at least partially arranged on the frame, the vehicle cover comprising a dashboard;
a roll-over protection system (ROPS) supported by the frame;
a windshield assembly pivotally mounted relative to the frame for pivoting about a pivot axis between a fully closed position of the windshield and a fully opened position of the windshield, the fully closed windshield assembly and the dashboard jointly defining a front of a cab under the ROPS, the windshield assembly comprising:
a windshield;
a windshield frame; and
a support arm rigidly positioned relative to the windshield frame; and
a latch which can secure and hold the windshield assembly in either of at least two fixed positions via engagement with the support arm, a first of the fixed positions being the closed position of the windshield and a second of the fixed positions being a partially opened position of the windshield.

2. The off-road vehicle of claim 1, wherein the windshield in the fully opened position is pivoted in the range from 60 to 70° from the fully closed position.

3. The off-road vehicle of claim 2, wherein the windshield in the partially-opened position is pivoted no more than 10° from the fully closed position.

4. The off-road vehicle of claim 3, further comprising at least one gas spring to support the windshield in the fully opened position.

5. The off-road vehicle of claim 1, wherein the latch is a barrel bolt latch comprising;
a housing mounted on a top of the dashboard; and
a bolt with a handle, the bolt being slidably movable relative to the housing via use of the handle, wherein a distal end of the bolt mates into either of at least two mating openings in the support arm.

6. The off-road vehicle of claim 5, wherein the support arm comprises a grip surface which includes ridges or other texture for better gripping while pulling the windshield assembly closed.

7. The off-road vehicle of claim 5, wherein the bolt is on a left side of the support arm, and wherein the housing extends to a right side of the support arm.

8. The off-road vehicle of claim 1, wherein the support arm defines an arc shaped slot centered about the pivot axis, and wherein the latch comprises a transversely extending handle bolt which is threaded into a housing, in which the handle bolt can be hand turned to tighten or loosen the handle bolt relative to the support arm and the housing, such that a shank of the handle bolt can be received in the arc shaped slot and the handle bolt tightened to frictionally support the windshield assembly in either the closed position or the partially opened position.

9. The off-road vehicle of claim 1, wherein the windshield assembly is hinged at its top to a transversely extending top bar of the ROPS via at least a left hinge and a right hinge, with the support arm positioned at a bottom of the windshield assembly at a position which is laterally between the left hinge and the right hinge, such that the left hinge, the right hinge and the support arm are spaced in a triangle.

10. The off-road vehicle of claim 1, wherein the windshield frame comprises a first windshield frame portion and a second windshield frame portion, each of the first and second windshield frame portions defining part of a receiving peripheral space for the windshield, wherein the first windshield frame portion is joined to the second windshield frame portion around the windshield and the joining completes clamping of the windshield to the windshield frame.

11. The off-road vehicle of claim 10, wherein the first windshield frame portion is an upper windshield frame portion comprising a transversely extending top bar and right and left downwardly extending side legs, wherein the second windshield frame portion is a lower windshield frame portion comprising a transversely extending bottom bar and right and left upwardly extending side legs, and wherein the support arm extends from a mid position of the transversely extending bottom bar.

12. The off-road vehicle of claim 1, wherein the windshield is formed of a thermoplastic material, wherein the off-road vehicle further comprises:
a wiper device having a motor disposed behind the windshield with an output shaft extending through a motor shaft through hole in the windshield, with a wiper blade attached and driven by the output shaft to wipe a front surface of the windshield; and
a spray nozzle having a connection stem extending through a nozzle mounting through hole in the windshield, the spray nozzle also having a spray outlet hole to spray washer fluid on the front surface of the windshield.

13. An off-road vehicle comprising:
a frame;
a plurality of wheels supporting the frame through a suspension;
a vehicle cover at least partially arranged on the frame, the vehicle cover comprising a dashboard;
a roll-over protection system (ROPS) supported by the frame, the ROPS having an upper front cross-bar;
a windshield assembly mounted on the upper front cross-bar by a right hinge and a left hinge, enabling the windshield assembly to pivot relative to the frame between a fully closed position of the windshield and a full opened position of the windshield, the windshield assembly and the dashboard jointly defining a front of a cab under the ROPS, the windshield assembly comprising:
a windshield;
a windshield frame having a transversely extending bottom bar; and
a support arm rigidly positioned at a mid position on the transversely extending bottom bar; and
a barrel bolt latch comprising;
a housing mounted on a top of the dashboard; and
a bolt with a handle, the bolt being slidably movable relative to the housing via use of the handle, wherein a distal end of the bolt mates into either of at least two mating openings in the support arm so as to secure and hold the windshield assembly in either of at least two fixed positions via engagement with the support arm, a first of the fixed positions being the closed position of the windshield and a second of the fixed positions being a partially opened position of the windshield.

14. The off-road vehicle of claim 13, wherein the bolt is on a left side of the support arm, and wherein the housing extends to a right side of the support arm.

15. The off-road vehicle of claim 13, wherein the windshield frame comprises a first windshield frame portion and a second windshield frame portion, each of the first and second windshield frame portions defining part of a receiving peripheral space for the windshield, wherein the first windshield frame portion is joined to the second windshield frame portion around the windshield and the joining completes clamping of the windshield to the windshield frame.

16. The off-road vehicle of claim 15, wherein the windshield is formed of a thermoplastic material, wherein the off-road vehicle further comprises:
a wiper device having a motor disposed behind the windshield with an output shaft extending through a motor shaft through hole in the windshield, with a wiper blade attached and driven by the output shaft to wipe a front surface of the windshield; and
a spray nozzle having a connection stem extending through a nozzle mounting through hole in the windshield, the spray nozzle also having a spray outlet hole to spray washer fluid on the front surface of the windshield.

17. An off-road vehicle comprising:
a frame;
a plurality of wheels supporting the frame through a suspension;
a vehicle cover at least partially arranged on the frame, the vehicle cover comprising a dashboard;
a roll-over protection system (ROPS) supported by the frame, the ROPS having an upper front cross-bar;
a windshield assembly mounted on the upper front cross-bar by a right hinge and a left hinge, enabling the windshield assembly to pivot relative to the frame about a pivot axis between a fully closed position of the windshield and a full opened position of the windshield, the windshield assembly and the dashboard jointly defining a front of a cab under the ROPS, the windshield assembly comprising:
a windshield;
a windshield frame having a transversely extending bottom bar; and
a support arm rigidly positioned at a mid position on the transversely extending bottom bar, the support arm defining an arc shaped slot centered about the pivot axis; and
a transversely extending handle bolt which is threaded into a housing mounted on a top of the dashboard, in which the handle bolt can be hand turned to tighten or loosen the handle bolt relative to the support arm and the housing, such that a shank of the handle bolt can be received in the arc shaped slot and the handle bolt tightened to frictionally support the windshield assembly in either the closed position or a partially opened position.

18. The off-road vehicle of claim 17, wherein the arc shaped slot enables the windshield assembly to be supported by the handle bolt at any partially-opened position pivoted from greater than 0 to 15° from the fully closed position.

19. The off-road vehicle of claim 17, wherein the windshield frame comprises a first windshield frame portion and a second windshield frame portion, each of the first and second windshield frame portions defining part of a receiving peripheral space for the windshield, wherein the first windshield frame portion is joined to the second windshield frame portion around the windshield and the joining completes clamping of the windshield to the windshield frame.

20. The off-road vehicle of claim 19, wherein the windshield is formed of a thermoplastic material, wherein the off-road vehicle further comprises:
a wiper device having a motor disposed behind the windshield with an output shaft extending through a motor shaft through hole in the windshield, with a wiper blade attached and driven by the output shaft to wipe a front surface of the windshield; and
a spray nozzle having a connection stem extending through a nozzle mounting through hole in the windshield, the spray nozzle also having a spray outlet hole to spray washer fluid on the front surface of the windshield.
